(19) United States
(12) Patent Application Publication
(10) Pub. No.: US 2026/0029627 A1
(43) Pub. Date: Jan. 29, 2026

(54) OPTICAL SYSTEM, IMAGING DEVICE AND MOVING BODY

(71) Applicant: Tamron Co., Ltd., Saitama (JP)

(72) Inventors: Hiroki EMURA, Saitama (JP); Yoshito Iwasawa, Saitama (JP)

(73) Assignee: Tamron Co., Ltd., Saitama (JP)

(21) Appl. No.: 19/243,724

(22) Filed: Jun. 20, 2025

(30) Foreign Application Priority Data
Jul. 23, 2024 (JP) 2024-117381

(51) Int. Cl. G02B 15/14; G02B 9/64

(52) U.S. Cl. CPC G02B 15/1421; G02B 9/64

(57) ABSTRACT

In order to solve the problem described above, an optical system according to the present invention includes, in order from the object side, a front group, a stop, and a rear group, in which the front group has a lens A having a positive refractive power on the most object side, and the rear group has a lens B having a negative refractive power on the most image side, an object side surface of the lens B has a concave surface on the object side, and the optical system satisfies the predetermined conditional formulas.

### CROSS-REFERENCE TO RELATED APPLICATIONS

This application is based on and claims the benefit of priority from Japanese Patent Application No. 2024-117381, filed on Jul. 23, 2024, the entire contents of which are incorporated herein by reference.

### BACKGROUND OF THE INVENTION

### Technical Field

The present invention relates to an optical system, an interchangeable lens apparatus and imaging device having the optical system, and a moving body having the optical system. In detail, the present invention relates to a compact optical system suitable for use in an imaging optical system of a digital input/output device such as a digital still camera or a digital video camera that uses a solid-state image sensor, and for use in an imaging device that obtains external information in a moving body such as a vehicle or a drone, and relates to a lens apparatus and imaging device having the optical system, and a moving body having the optical system or the imaging device.

### Related Art

Conventionally, imaging apparatuses using solid-state image sensors, such as digital still cameras and digital video cameras, have been widely used. As solid-state image sensors used in these imaging devices become more pixel-intensive, optical systems are required to achieve high resolution performance while maintaining compactness and lightweighting. Furthermore, there is a strong demand for a large aperture and low cost along with the compactness of optical systems, and these demands are being strongly pursued in optical systems.

To satisfy these requirements, for example, a compact optical system has been proposed including a first lens group having a positive refractive power, a second lens group having a positive refractive power, and a third lens group having a negative refractive power, which suppresses various aberrations (see “Japanese Patent Application Laid-Open No. 2021-189351”).

Compactness of the optical system can be effectively achieved by adopting a telephoto type power arrangement having a positive refractive power on the object side and a negative refractive power on the image side. However, the stronger the power arrangement, the more difficult it becomes to favorably correct various aberrations with a small number of lens pieces. Therefore, to achieve both compactness and high performance in the optical system, it is necessary to optimize the refractive power of each lens and the lens configuration.

The problem to be solved by the present invention is to provide a compact and high-performance optical system, an imaging device, and a moving body having the same.

### SUMMARY OF THE INVENTION

In order to solve the problem described above, an optical system according to the present invention includes, in order from the object side, a front group, a stop, and a rear group, in which the front group has a lens A having a positive refractive power disposed on the most object side, and the rear group has a lens B having a negative refractive power disposed on the most image side, an object side surface of the lens B has a concave surface on the object side, and the optical system satisfies following conditional formulas:

$$1.59 < NdLB < 2.3 , \qquad ( 1 )$$

$$0.2 < fR / f < 0.9 , \qquad ( 3 - 2 )$$

$$25. < ν dLA < 110. , \qquad ( 5 )$$

$$0.18 < BF / f < 0.45 , and \qquad ( 12 - 1 )$$

$$- 0.89 < FLB / FLA < - 0.2 , \qquad ( 15 )$$

here,
NdLB is a refractive index at d-line of the lens B,
fR is a focal length of the rear group,
f is a focal length of the optical system,
νdLA is an Abbe constant at d-line of the lens A,
BF is an air-equivalent distance from a lens surface on a most image side of the rear group to an image plane,
f is a focal length of the optical system,
FLA is a focal length of the lens A, and
FLB is a focal length of the lens B.

In order to solve the problem described above, an optical system according to the present invention includes, in order from the object side, a front group, a stop, and a rear group, in which the front group has a lens A having a positive refractive power disposed on the most object side, and the rear group has a lens B having a negative refractive power disposed on the most image side, an object side surface of the lens B has a concave surface on the object side, and the optical system satisfies following conditional formulas:

$$1.63 < NdLB < 2.3 \qquad ( 1 - 1 )$$

$$0.2 < fR / f < 0.9 , \qquad ( 3 - 2 )$$

$$- 0.83 < FLB / FLA < - 0.2 , and \qquad ( 15 - 1 )$$

$$0.2 < CRsz / f < 25. , \qquad ( 13 )$$

here,
NdLB is a refractive index at d-line of the lens B,
fR is a focal length of the rear group,
f is a focal length of the optical system,
FLA is a focal length of the lens A,
FLB is a focal length of the lens B, and
CRsz is a curvature radius of a lens surface on an image side of the stop.

In order to solve the problem described above, the imaging device according to the present invention includes the optical system described above, and an image sensor that receives an optical image formed by the optical system and converts the optical image into an electrical image signal.

In order to solve the problem described above, the moving body according to the present invention includes an imaging device having the optical system described above and an image sensor that receives an optical image formed by the optical system and converts the optical image into an electrical image signal.

### Effects of the Invention

According to the present invention, a compact and high-performance optical system, an imaging device and a moving body can be provided.

### BRIEF DESCRIPTION OF THE DRAWINGS

FIG. 1 illustrates a cross-sectional view of an optical system of Example 1 of the present invention;

FIG. 2 illustrates the spherical aberration, astigmatism, and distortion diagrams of the optical system of Example 1 of the present invention;

FIG. 3 illustrates a cross-sectional view of an optical system of Example 2 of the present invention at the time of imaging a subject at an infinity distance;

FIG. 4 illustrates the spherical aberration, astigmatism, and distortion diagrams of the optical system of Example 2 of the present invention at the time of imaging a subject at an infinity distance;

FIG. 5 illustrates a cross-sectional view of an optical system of Example 3 of the present invention;

FIG. 6 illustrates the spherical aberration, astigmatism, and distortion diagrams of the optical system of Example 3 of the present invention;

FIG. 7 illustrates a cross-sectional view of an optical system of Example 4 of the present invention;

FIG. 8 illustrates the spherical aberration, astigmatism, and distortion diagrams of the optical system of Example 4 of the present invention;

FIG. 9 illustrates a cross-sectional view of an optical system of Example 5 of the present invention; and

FIG. 10 illustrates the spherical aberration, astigmatism, and distortion diagrams of the optical system of Example 5 of the present invention.

### DESCRIPTION OF THE EMBODIMENTS

Hereinafter, embodiments of an optical system, an imaging device and a moving body according to the present invention are described.

### 1. Optical System

### 1-1. Optical Configuration of Optical System

First, the optical configuration of the optical system according to the present invention is described. The optical system of the present embodiment includes, in order from the object side, a front group, a stop, and a rear group.

The optical system has lens groups that include at least one piece of lens, on each of the object side and the image side of the stop. By arranging the lens groups on each of the object side and the image side of the stop, aberrations are likely to offset each other in front and rear lens groups of the stop, facilitating the correction of off-axis coma aberration. Here, “stop” refers to the aperture stop that defines the light beam diameter of the optical system, that is, the aperture stop that defines the F-number of the optical system.

The optical system has lens groups that include at least one piece of lens, on each of the object side and the image side of the stop. By arranging the lens groups on each of the object side and the image side of the stop, aberrations are likely to offset each other before and after the stop, making it effective in reducing the number of lens pieces. This leads to low cost and reduced volume of the lenses, thus achieving a lightweight optical system. It is preferable that the total number of lenses having a refractive power included in the front group and the rear group is nine pieces or less, in terms of low cost and lightweighting. It is further preferable that the total number of lenses is eight pieces or less, and it is still further preferable that the total number of lenses is seven pieces or less.

In a case where a lens having a negative refractive power and a lens having a positive refractive power included in the optical system are bonded, the bonded lens may crack when the temperature change is great. The difference between the linear expansion coefficient of a lens having a negative refractive power and the linear expansion coefficient of a lens having a positive refractive power causes a difference in shape change due to temperature change, and the larger the diameter, the larger the shape change, resulting in cracking of the bonded lens. Therefore, it is preferable to reduce the difference between the average linear expansion coefficient α1n of a lens having a negative refractive power and the average linear expansion coefficient alp of a lens having a positive refractive power, when the average linear expansion coefficient α means the ratio of the change in sample length at unit temperature. Furthermore, |α1p−α1n|<50×10⁻⁷/° C. is preferable to prevent cracking of a bonded lens having a large diameter.

The optical configuration of the optical system is described in more detail below.

### (1) Front Group

The front group is a lens group arranged on the object side of the stop in the optical system. Here, an optical element having no refractive power or an extremely small refractive power may be arranged on the object side of the lens on the most object side of the front group. Such optical elements include, for example, prisms that reflect and bend the optical axis of the optical system, protective filters to protect the lens from dirt and scratches, ND filters used to reduce the amount of incident light, PL filters to adjust color, and various other filters.

The front group has the lens A having a positive refractive power on the most object side. Having the convergence action on the most object side is advantageous for large apertures. In addition, even with a large aperture, a large lens diameter can be avoided. This leads to reduced volume of the lenses, thus achieving a lightweight optical system.

As long as the front group has the lens A having a positive refractive power on the most object side, its specific optical system configuration is not particularly limited. Therefore, the front group only needs to have at least one piece of lens having a positive refractive power. It is preferable that the front group includes a plurality of pieces of lenses having a positive refractive power, as this facilitates correction of chromatic aberration and spherical aberration.

As long as the front group has the lens A having a positive refractive power on the most object side, its specific optical system configuration is not particularly limited. Since the front group has a convergence action on the most object side, the front group can have a telephoto configuration by making the most image side surface of the front group a surface having a negative refractive power, or by making the most image side of the front group a lens having a negative refractive power. Such a configuration facilitates compactness even with a long focal length, and also achieves a compact stop diameter even with a large aperture, which is effective in compacting the optical system.

As long as the front group has the lens A having a positive refractive power on the most object side, its specific optical system configuration is not particularly limited. In order to achieve high optical performance while achieving a compact, lightweight, and low cost optical system, it is preferable to have four pieces or fewer pieces of lenses having a positive refractive power in the front group, and it is more preferable to have three pieces or fewer pieces of lenses having a positive refractive power in the front group.

### (2) Rear Group

The rear group is a lens group arranged on the image side of the stop. Here, an optical element having no refractive power or an extremely small refractive power may be arranged on the image side of the lens on the most image side of the rear group. Such optical elements include, for example, prisms that reflect and bend the optical axis of the optical system, cover glass to protect the image sensor from dirt and scratches, bandpass filters used to cut specific wavelengths, and low-pass filters that attenuate specific frequencies to reduce moire, and the like.

The rear group has the lens B having a negative refractive power on the most image side. Having the divergence action on the most image side allows for a telephoto configuration, which is advantageous for compactness in the overall length direction and compactness in the diameter of the lenses on the image side.

The rear group has the lens B having a negative refractive power on the most image side. The object side surface of the lens B has a concave surface on the object side. This allows for favorable correction of off-axis coma aberration and high performance.

It is preferable that the surface on the most object side of the rear group has a convex shape on the object side. Having a surface having the convergence action on the most object side of the rear group allows for a telephoto configuration in which the rear group has a convergence action on the most object side and a divergence action on the most image side, thereby achieving compactness in the overall length direction. In addition, spherical aberration is effectively corrected and high performance is achieved.

As long as the rear group has the lens B having a negative refractive power on the most image side, its specific optical system configuration is not particularly limited. It is preferable that the air lens formed by the image side surface of the lens adjacent to the object side of the lens B and the object side surface of the lens B has a convex shape. Having a convex-shaped air lens, that is, a divergence action, on the object side of the lens B is advantageous for the compactness of the lens B in the radial direction, thus achieving compactness and lightweighting.

As long as the rear group has the lens B having a negative refractive power on the most image side, its specific optical system configuration is not particularly limited. In order to achieve high optical performance while achieving a compact, lightweight, and low cost optical system, it is preferable to have six pieces or fewer pieces of lenses having a refractive power in the rear group, and it is more preferable to have five pieces or fewer pieces of lenses having a refractive power in the rear group.

In the rear group, since the lens B has a negative refractive power on the most image side, there is at least one piece of lens having a negative refractive power. It is preferable that the refractive index of the lens having a negative refractive power included in the rear group is high. This facilitates Petzval correction, corrects field curvature, which is preferable in terms of high performance. Since the optical system has a positive refractive power as a whole, a high refractive index of the lens having a negative refractive power in the rear group is preferable for Petzval correction. The refractive index of the lens having a negative refractive power in the rear group is further preferable to be 1.74<Ndn, and the lower limit is further preferable to be 1.75, 1.76, 1.77, 1.78, 1.79, 1.80, 1.81, 1.82, 1.83, 1.84, 1.85, 1.86, 1.87, 1.88 in this order.

### (3) Focus Group

In such an optical system, the presence or absence of a focus group is not particularly limited. In a case where a focus group is provided, at least one piece of the lenses of the optical system can be used as the focus group, and the focus group can be moved in the optical axis direction to focus on the subject at the time of focusing. The position and refractive power of the lens used as the focus group in the optical system are not particularly limited.

In the case where the focus group is provided in the optical system, the number of lenses of the focus group is not particularly limited, and the number of lens pieces of the focus group may be one piece or a plurality of pieces. However, in order to suppress the aberration fluctuation that occurs when focusing on a close subject, it is preferable for the focus group to have a plurality of pieces of lenses.

In order to achieve a compact and lightweight focus group, it is preferable for the focus group to have a single lens unit. Here, a single lens unit refers to one piece of single lens, or a lens unit such as a bonded lens in which a plurality of single lenses is integrated without any air space therebetween. In other words, even in a case of a single lens unit having a plurality of optical surfaces, only the most object side surface and the most image side surface of the single lens unit are in contact with the air, and the other surfaces are not in contact with the air. In the present description, the single lens may be either a spherical lens or an aspherical lens. The aspherical lens also includes a so-called composite aspherical lens with an aspherical film attached to the surface. In particular, from the viewpoint of achieving a compact and lightweight focus group while suppressing aberration fluctuations that occur when focusing on the close subject as described above, it is further preferable that the focus group includes a bonded lens in which a plurality of pieces of single lenses is integrated without any air space therebetween.

In a case where the focus group includes one single lens unit described above, the focus group includes no air space. Therefore, a compact and lightweight focus group can be achieved compared to a configuration of a focus group in which a plurality of single lenses is arranged with air space therebetween. As a result, a compact and lightweight mechanical member for moving the focus group in the optical axis direction at the time of focusing (hereinafter referred to as “focus drive mechanism”) can be achieved, and a compact and lightweight optical system unit can be achieved as a whole. Note that the optical system unit includes, in addition to the optical system, a lens barrel that houses the optical system and the focus drive mechanism described above, and the like.

In a case where a focus group is provided in the optical system, the arrangement of the focus group is not particularly limited, and it is preferable to use any one of the lens groups of the rear group, or a part of the lens groups of the rear group, as the focus group. Since the front group has a convergence action on the most object side and includes a relatively large diameter lens on the most object side, it is facilitated to achieve a compact and lightweight focus group by arranging the lens groups of the rear group or a part of the lens groups of the rear group as the focus group.

The focus group may have a positive refractive power or a negative refractive power. It is preferable that in a case where the focus group has a positive refractive power, the lens group on the object side of the focus group has a negative refractive power. It is preferable that in a case where the focus group has a negative refractive power, the refractive power on the object side of the focus group is positive. This facilitates increasing the lateral magnification of the focus group, which makes it likely to increase the focus sensitivity of the focus group. As a result, a small amount of movement is required for focusing, which is preferable in terms of compactness.

Note that the focus group included in the optical system is not limited to one focus group, but a plurality of lens groups or a part of a plurality of lens groups may be used as the focus group. In other words, focusing may be performed by a floating method. It is preferable to adopt the floating method, since the floating method allows for better spherical aberration and image quality at the time of closer focusing, thus realizing an optical system having a higher optical performance.

### (4) Anti-Vibration Group

In such an optical system, the presence or absence of an anti-vibration group is not particularly limited. Correction of image blurring that occurs due to vibration transmitted to the imaging device during imaging can be performed by electrically correcting the image or by moving the image sensor. In a case where the anti-vibration group is not provided in the optical system, image blurring can be corrected by these methods.

In a case where the anti-vibration group is provided in the optical system, the method is not particularly limited as long as the image shift is achieved by decentering at least one piece of lens among the lenses of the optical system.

For example, when at least one piece of lens among the lenses of the optical system is used as the anti-vibration group and the image shift is performed by moving the anti-vibration group in a direction approximately perpendicular to the optical axis, a compact optical system unit as a whole, including the lens barrel, can be achieved, which is preferable in terms of achieving compactness.

In a case where the anti-vibration group is provided in the optical system, the arrangement of the anti-vibration group is not particularly limited, and it is further preferable to provide the anti-vibration group in the rear group. Since the front group has a convergence action on the most object side and includes a relatively large diameter lens on the most object side, the diameter of the incident light beam to the rear group can be made smaller than the diameter of the incident light beam to the front group. Therefore, by arranging the lens groups of the rear group or a part of the lens groups of the rear group as the anti-vibration group, a compact and lightweight anti-vibration group can be achieved compared to a case where the anti-vibration group is arranged in the front group.

In a case where the anti-vibration group is provided in the optical system, the number of pieces of lenses of the anti-vibration group is not particularly limited. It is preferable that the anti-vibration group includes a plurality of pieces of lenses, as this can suppress aberration fluctuation during anti-vibration. In this case, it is preferable for the anti-vibration group to have at least one piece of lens having a negative refractive power and at least one piece of lens having a positive refractive power. In a case where the anti-vibration group has at least one piece of lens having a negative refractive power and at least one piece of lens having a positive refractive power, the occurrence of chromatic aberration during anti-vibration can be suppressed, and an optical system having a higher optical performance can be realized.

### 1-2. Conditional Formula

It is preferable that the optical system adopts the configuration described above and satisfies the conditional formulas to be described below.

### 1-2-1. Conditional Formula (1)

It is preferable that the optical system satisfies the following conditional formula:

$$1.59 < NdLB < 2.3 , \qquad ( 1 )$$

here,
NdLB is a refractive index at d-line of the lens B.

The conditional formula (1) described above is a formula that defines the refractive index at d-line of the lens B on the most image side of the rear group of the optical system. Since the optical system as a whole has a convergence action, the object side of the lens B having a negative refractive power on the most image side has a combined positive refractive power. It is important to suppress the curvature radius of the most object side surface of the lens B within an appropriate range for light rays incident to the lens B having a divergence action, both in terms of performance and manufacturability. Since the refractive power of the most object side surface of the lens B is determined by the curvature radius of the surface and the refractive index of the glass material, defining the refractive index within a certain range makes it likely to suppress the refractive power of the surface within an appropriate range. Here, in a case where the conditional formula (1) is satisfied, an optical system having high off-axis performance can be achieved while the cost is suppressed. In a case of the so-called composite aspherical lens with an aspherical film attached to the surface of the lens B on the most image side of the rear group, NdLB is the refractive index of the base lens, not the refractive index of the aspherical film.

On the other hand, when the value of the conditional formula (1) described above is equal to or greater than the upper limit, the cost of the glass material becomes too high, which is not preferable in terms of low cost. When the value of the conditional formula (1) described above is equal to or less than the lower limit, it becomes difficult to correct field curvature and to suppress the curvature radius within an appropriate range, resulting in deterioration of manufacturability. Therefore, it is not preferable in terms of off-axis performance and manufacturability.

In order to obtain the effect described above, the upper limit of the conditional formula (1) described above is preferable to be 2.20, 2.15, 2.12, 2.08, 2.06, 2.03, 2.01, 1.99, and 1.96, in this order. The lower limit of the conditional formula (1) described above is preferable to be 1.60, 1.61, 1.62, 1.63, 1.64, 1.65, 1.67, and 1.69, in this order.

### 1-2-2. Conditional Formula (2)

It is preferable that the optical system satisfies the following conditional formula:

$$1.6 < TLSB / BF < 10. , \qquad ( 2 )$$

here,
TLSB is a distance from the stop to an image side surface of the lens B, and
BF is an air-equivalent distance from a lens surface on a most image side of the rear group to an image plane.

The conditional formula (2) described above is a formula for defining the ratio of the distance from the stop to the image side surface of the lens B to the air-equivalent distance from the lens surface on the most image side of the rear group to the image plane. In other words, it is a formula equivalent to defining the position of the lens B on the most image side of the rear group between the stop and the image plane. In a case where the conditional formula (2) is satisfied, the position of the lens B is optimized between the stop and the image plane, facilitating the correction of coma aberration and facilitating the achievement of high performance.

On the other hand, when the value of the conditional formula (2) described above is equal to or greater than the upper limit, the back focus becomes short. Such a case is not preferable since it becomes difficult to arrange optical elements such as a low-pass filter. It is also not preferable since it leads to the lens B on the most image side to have a large diameter. On the other hand, when the value of the conditional formula (2) described above is equal to or less than the lower limit, the stop and the lens B on the most image side become shorter than the back focus. As a result, the light ray height of the off-axis light ray in the lens B does not increase, resulting that coma aberration correction capability becomes small, which is not preferable since high performance becomes difficult.

In order to obtain the effect described above, the lower limit of the conditional formula (2) is preferable to be 1.70, 1.80, 1.90, 2.00, 2.10, 2.20, 2.30, 2.40, 2.50, 2.60, 2.70, 2.80, 2.90, and 3.00, in this order. The upper limit of the conditional formula (2) described above is preferable to be 9.50, 9.00, 8.50, 8.00, 7.80, 7.60, and 7.40, in this order.

### 1-2-3. Conditional Formula (3)

It is preferable that the optical system satisfies the following conditional formula:

$$0.2 < fR / f < 1.05 , \qquad ( 3 )$$

here,
fR is a focal length of the rear group, and
f is a focal length of the optical system.

The conditional formula (3) described above is a formula that defines the ratio of the focal length of the rear group to the focal length of the optical system. In a case where the conditional formula (3) is satisfied, the rear group has a positive refractive power, and has a convergence action on the image side of the optical system. This facilitates the large aperture of the optical system. In addition, too strong refractive power leads to an increase in the number of lens pieces and deterioration of aberrations, and therefore, there is an appropriate range for achieving both high performance and low cost. By satisfying the conditional formula (3), each aberration is corrected to an appropriate range and a large-aperture optical system having a small number of lens pieces is achieved.

In contrast, when the value of the conditional formula (3) is equal to or greater than the upper limit, the focal length of the rear group relative to the focal length of the optical system becomes large. Such a case is not preferable in terms of the large aperture since the convergence action of the rear group becomes weak. On the other hand, when the value of the conditional formula (3) is equal to or less than the lower limit, the focal length of the rear group relative to the focal length of the optical system becomes small. In this case, aberration correction capability of the rear group is excessively necessary, which is not preferable in terms of high performance, and the number of lens pieces in the rear group increases, which is not preferable in terms of cost.

In order to obtain the effect described above, the upper limit of the conditional formula (3) described above is preferable to be 1.03, 1.01, 0.99, 0.97, 0.95, 0.94, 0.93, 0.92, 0.91, 0.90, 0.89, 0.88, 0.87, 0.86, 0.85, 0.84, 0.83, 0.82, 0.81, 0.80, 0.79, 0.78, 0.77, 0.76, and 0.75, in this order. The lower limit of the conditional formula (3) described above is preferable to be 0.22, 0.24, 0.26, 0.28, 0.30, 0.32, 0.34, 0.36, 0.38, 0.40, 0.42, 0.44, 0.46, 0.48, 0.50, 0.52, 0.54, 0.56, 0.58, and 0.60, in this order.

### 1-2-4. Conditional Formula (4)

It is preferable that the optical system satisfies the following conditional formula:

$$- 1.85 < FLB / f < - 0.45 , \qquad ( 4 )$$

here,
FLB is a focal length of the lens B, and
f is a focal length of the optical system.

The conditional formula (4) described above is a formula for defining the ratio of the focal length of the lens B on the most image side of the rear group to the focal length of the optical system. Having a negative refractive power on the most image side makes it likely to obtain a telephoto configuration. However, when the refractive power of the lens on the most image side becomes too strong, the magnification action becomes large, and aberrations are generated. Therefore, to achieve both compactness and high performance, it is important to maintain the refractive power of the lens on the most image side within an appropriate refractive power range. Satisfying the conditional formula (4) allows for both compactness and high performance.

In contrast, when the value of the conditional formula (4) is equal to or greater than the upper limit, the refractive power of the lens B on the most image side becomes too large, resulting in a large magnification action. This leads to generate coma aberration and field curvature, which is not preferable since high performance becomes difficult. When the value of the conditional formula (4) is equal to or less than the lower limit, the refractive power of the lens B on the most image side becomes too small, and the telephoto power arrangement becomes weak. Therefore, it is not preferable since compactness becomes difficult.

In order to obtain the effect described above, the upper limit of the conditional formula (4) described above is preferable to be −0.46, −0.48, −0.50, −0.52, −0.54, −0.56, −0.58, −0.60, −0.62, −0.64, −0.66, and −0.68, in this order. The lower limit of the conditional formula (4) described above is preferable to be −1.70, −1.65, −1.60, −1.55, −1.50, −1.45, −1.40, −1.35, −1.30, −1.25, −1.20, −1.15, −1.10, −1.05, −1.00, and −0.95, in this order.

### 1-2-5. Conditional Formula (5)

It is preferable that the optical system satisfies the following conditional formula:

$$25. < ν dLA < 110. , \qquad ( 5 )$$

here,
νdLA is an Abbe constant at d-line of the lens A.

The conditional formula (5) described above is a formula for defining the Abbe constant of the lens A having a positive refractive power on the most object side of the front group. In a case where the conditional formula (5) is satisfied, the axial chromatic aberration of the optical system can be corrected, facilitating the achievement of high performance of the optical system.

In contrast, when the value of the conditional formula (5) is equal to or less than the lower limit, the dispersion becomes large, and correction of axial chromatic aberration becomes difficult, which is not preferable. When the value of conditional formula (5) is equal to or greater than the upper limit, the dispersion becomes small, which is preferable in terms of chromatic aberration correction, but not preferable in terms of low cost, since glass with small dispersion is expensive.

In order to obtain the effect described above, the upper limit of the conditional formula (5) described above is preferable to be 100.00, 96.00, 95.00, 92.00, 91.00, 87.00, 83.00, 82.00, 79.00, 78.00, 76.50, 75.60, 75.00, 74.00, 73.00, 72.00, and 70.00, in this order. The lower limit of the conditional formula (5) described above is preferable to be 26.00, 27.00, 28.00, 29.00, 30.00, 32.00, 35.00, 37.00, and 40.00, in this order.

### 1-2-6. Conditional Formula (6)

It is preferable that the optical system satisfies the following conditional formula:

$$18. < ν dLB < 52. , \qquad ( 6 )$$

here,
νdLB is an Abbe constant at d-line of the lens B.

The conditional formula (6) described above is the formula for defining the Abbe constant of the lens B having a negative refractive power on the most image side of the rear group. In a case where the conditional formula (6) is satisfied, the lateral chromatic aberration of the optical system can be corrected, facilitating the achievement of high performance of the optical system.

In contrast, when the value of the conditional formula (6) is equal to or less than the lower limit, correction of lateral chromatic aberration of short wavelength becomes difficult, which is not preferable. When the value of conditional formula (6) is equal to or greater than the upper limit, correction of chromatic aberration of magnification of long wavelength becomes difficult, which is not preferable.

In order to obtain the effect described above, the upper limit of the conditional formula (6) described above is preferable to be 51.00, 50.00, 48.00, 47.00, 46.50, 46.00, 45.50, 45.00, 44.00, 43.00, and 42.00, in this order. The lower limit of the conditional formula (6) described above is preferable to be 18.20, 18.40, 18.80, 19.20, 19.80, 20.30, 20.80, 21.00, 21.20, and 21.40, in this order.

### 1-2-7. Conditional Formula (7)

It is preferable that the optical system satisfies the following conditional formula:

$$- 1.18 < CRBf / f < - 0.2 , \qquad ( 7 )$$

here,
CRBf is a curvature radius of an object side surface of the lens B, and
f is a focal length of the optical system.

The conditional formula (7) described above is a formula for defining the shape of the object side surface of the lens B on the most image side of the rear group. In a case where the ratio of the object side surface curvature radius of the lens B on the most image side of the rear group to the focal length of the optical system satisfies the conditional formula (7) described above, coma aberration can be corrected favorably, and an optical system having high image formation performance can be realized. In the case of a so-called composite aspherical lens with an aspherical film attached to a lens unit having a positive refractive power arranged on the most object side, CRBf is the curvature radius of the base lens, not the curvature radius of the aspherical film.

In contrast, when the value of the conditional formula (7) is equal to or less than the lower limit, the curvature radius of the object side surface of the lens B on the most image side becomes large, and the correction amount of coma aberration becomes small, which is not preferable in terms of high performance. When the value of conditional formula (7) is equal to or greater than the upper limit, the curvature radius of the object side surface of the lens B on the most image side becomes small, and the generation amount of coma aberration becomes large, which is not preferable in terms of high performance.

In order to obtain the effect described above, the lower limit of the conditional formula (7) is preferable to be −1.16, −1.13, −1.10, −1.00, −0.95, −0.90, −0.85, −0.80, −0.75, −0.70, −0.65, and −0.60, in this order. The upper limit of the conditional formula (7) described above is preferable to be −0.23, −0.26, −0.28, −0.30, −0.32, −0.34, −0.36, −0.38, −0.40, and −0.42, in this order.

### 1-2-8. Conditional Formula (8)

It is preferable that the optical system satisfies the following conditional formula:

$$f / EPD < 2.6 , \qquad ( 8 )$$

here,
f is a focal length of the optical system, and
EPD is an entrance pupil diameter of the optical system.

The conditional formula (8) described above is a formula that defines the ratio of the entrance pupil diameter of the optical system to the focal length of the optical system. In a case where the conditional formula (8) is satisfied, it is facilitated to realize a large aperture for the optical system.

In contrast, when the value of the conditional formula (8) described above is equal to or greater than the upper limit, the entrance pupil diameter relative to the focal length of the optical system becomes small, which is not preferable in terms of the large aperture. Although the lower limit of the value of the conditional formula (8) is not specified, an excessively large entrance pupil diameter leads to an increase in the number of lens pieces for aberration correction. Therefore, a lower limit of 0.80 or more is preferable in terms of cost.

In order to obtain the effect described above, the upper limit of the conditional formula (8) is preferable to be 2.55, 2.51, 2.48, 2.45, 2.42, 2.38, 2.33, 2.28, 2.23, 2.18, 2.13, 2.10, 2.08, 2.05, 2.00, 1.96, 1.93, 1.90, 1.88, 1.85, 1.82, 1.79, 1.76, 1.73, 1.70, and 1.68, in this order. The lower limit of the conditional formula (8) described above is preferable to be 0.85, 0.90, 0.94, 0.99, 1.05, 1.10, 1.18, 1.25, 1.30, and 1.38, in this order.

### 1-2-9. Conditional Formula (9)

It is preferable that the optical system satisfies the following conditional formula:

$$0.65 < FLA / f < 3.8 , \qquad ( 9 )$$

here,
FLA is a focal length of the lens A, and
f is a focal length of the optical system.

The conditional formula (9) described above is a formula for defining the ratio of the focal length of the lens A on the most object side of the front group to the focal length of the optical system. Having a positive refractive power on the most object side makes it likely to obtain a telephoto configuration. However, when the refractive power of the lens group on the most object side becomes too strong, the convergence action becomes large, and spherical aberration and field curvature are generated. Therefore, to achieve both compactness and high performance, it is important to maintain the refractive power of the lens on the most object side within an appropriate refractive power range. Satisfying the conditional formula (9) allows for both compactness and high performance.

In contrast, when the value of the conditional formula (9) is equal to or greater than the upper limit, the refractive power of the lens A on the most object side becomes too small, resulting in a small convergence action. Therefore, it is not preferable since compactness becomes difficult. When the value of the conditional formula (9) is equal to or less than the lower limit, the refractive power of the lens A on the most object side becomes too large, resulting in a large convergence action. This leads to generate spherical aberration and field curvature, which is not preferable since it becomes difficult to achieve high performance.

In order to obtain the effect described above, the upper limit of the conditional formula (9) described above is preferable to be 3.70, 3.60, 3.50, 3.40, and 3.30, in this order. The lower limit of the conditional formula (9) described above is preferable to be 0.70, 0.75, 0.80, 0.85, 0.90, 0.95, 1.00, 1.05, 1.10, 1.15, 1.20, 1.25, 1.30, 1.35, and 1.40, in this order.

### 1-2-10. Conditional Formula (10)

It is preferable that the optical system satisfies the following conditional formula:

$$- 3.2 < ( CRBf + CRBr ) / ( CRBf - CRBr ) < - 0.53 , \qquad ( 10 )$$

here,
CRBf is a curvature radius of an object side surface of the lens B, and
CRBr is a curvature radius of an image side surface of the lens B.

The conditional formula (10) described above is a formula for defining the shape of the lens B arranged on the most image plane side. When the conditional formula (10) is satisfied, the absolute value of the curvature radius of the object side surface becomes small, which is preferable for high performance since coma aberration is suppressed.

In contrast, when the value of the conditional formula (10) is equal to or greater than the upper limit, the negative refractive power of the image side surface becomes strong, and correction of coma aberration becomes difficult, which is not preferable in terms of high performance. When the value of the conditional formula (10) is equal to or less than the lower limit, the curvature radius of the object side surface becomes large, and correction of coma aberration becomes difficult. Further, the negative refractive power of the lens B becomes weak, resulting in difficulty in compacting the lens in both the overall length direction and radial direction, which is not preferable.

In order to obtain the effect described above, the upper limit of the conditional formula (10) described above is preferable to be −0.54, −0.55, −0.56, −0.58, −0.60, −0.62, −0.64, −0.66, −0.68, and −0.70, in this order. The lower limit of the conditional formula (10) described above is preferable to be −3.10, −3.00, −2.90, −2.80, −2.70, −2.60, −2.50, −2.40, −2.30, −2.20, −2.10, −2.00, −1.90, −1.80, −1.70, and −1.60, in this order.

### 1-2-11. Conditional Formula (11)

It is preferable that the optical system satisfies the following conditional formula:

$$1.42 < NdLA < 2.3 , \qquad ( 11 )$$

here,
NdLA is a refractive index at d-line of the lens A.

The conditional formula (11) described above is a formula for defining the refractive index at d-line of the lens A on the most object side of the front group. By satisfying the conditional formula (11), the generation amount of spherical aberration is within an appropriate range while the refractive power of the lens A is appropriate.

In contrast, when the value of the conditional formula (11) is equal to or less than the lower limit, the refractive index becomes small, and the curvature radius of the surface on the most object side becomes small. Such a case is not preferable since correction of spherical aberration becomes difficult. The refractive index becomes large when the value of the conditional formula (11) is equal to or greater than the upper limit. Since glass having a high refractive index is expensive, too high a refractive index is not preferable in terms of low cost. Since glass having a high refractive index has a high specific gravity, it is also not preferable in terms of lightweighting.

In order to obtain the effect described above, the lower limit of the conditional formula (11) is preferable to be 1.45, 1.49, 1.50, 1.52, 1.54, 1.56, 1.58, 1.60, 1.62, 1.64, 1.66, 1.68, 1.70, 1.72, 1.74, 1.76, 1.78, and 1.80, in this order. The upper limit of the conditional formula (11) described above is preferable to be 2.25, 2.20, 2.18, 2.17, 2.16, 2.15, 2.14, 2.13, 2.12, 2.11, and 2.10, in this order.

### 1-2-12. Conditional Formula (12)

It is preferable that the optical system satisfies the following conditional formula:

$$0.1 < BF / f < 0.55 , \qquad ( 12 )$$

here,
BF is an air-equivalent distance from a lens surface on the most image side of the rear group to the image plane, and
f is a focal length of the optical system.

The conditional formula (12) described above is a formula that defines the ratio of the air equivalent value of the distance on the optical axis from the most image side surface to the image plane of the optical system, to the focal length of the optical system. It is necessary to arrange optical elements such as low-pass filters and cover glass between the most image side surface and the image plane of the optical system. Therefore, it is important to make the back focus of the optical system within the optimum range in order to arrange the optical elements while achieving compactness. In a case where the conditional formula (12) is satisfied, the back focus of the optical system is within the optimum range, facilitating the compactness.

In contrast, when the value of the conditional formula (12) described above is equal to or greater than the upper limit, the overall optical length of the optical system becomes long, and the weight of the optical system, including the mechanism, becomes heavy. Therefore, it is not preferable in terms of compactness and lightweighting. On the other hand, when the value of the conditional formula (12) described above is equal to or less than the lower limit, it becomes difficult to arrange optical elements such as low-pass filters and cover glass, which is not preferable. It is also not preferable since it leads to the lens B, which is the final lens, to have a large diameter.

In order to obtain the effect described above, the upper limit of the conditional formula (12) described above is preferable to be 0.54, 0.52, 0.50, 0.48, 0.46, 0.45, 0.44, 0.43, 0.41, 0.39, 0.37, 0.35, and 0.34, in this order. The lower limit of the conditional formula (6) described above is preferable to be 0.11, 0.12, 0.13, 0.14, 0.15, 0.16, 0.17, and 0.18, in this order.

### 1-2-13. Conditional Formula (13)

It is preferable that the optical system satisfies the following conditional formula:

$$0.2 < CRsz / f < 25. , \qquad ( 13 )$$

here,
CRsz is a curvature radius of a surface on an image side of the stop, and
f is a focal length of the optical system.

The conditional formula (13) described above is a formula for defining the ratio of the curvature radius of the surface on the image side of the stop, that is, the curvature radius of the surface on the most object side of the rear group, to the focal length of the optical system. In a case where the conditional formula (13) is satisfied, the surface on the most object side of the rear group has a convex surface on the object side, and the generation amount of aberration on the surface on the most object side of the rear group can be made within an appropriate range. This allows for high performance. In addition, the convergence action on the most object side of the rear group facilitates the compactness of the optical system.

In contrast, when the value of conditional formula (13) is equal to or less than the lower limit, the curvature radius of the surface on the most object side of the rear group becomes too small, resulting in generation of spherical aberration and coma aberration and difficulty in high performance, which is not preferable. When the value of the conditional formula (13) is equal to or greater than the upper limit, the curvature radius of the surface on the most object side of the rear group becomes too large. This increases the overall optical length, which is not preferable in terms of compactness. When the curvature radius of the surface on the image side of the stop is large, harmful light reflected off the image plane is incident again to the imaging surface, likely causing ghosting. Therefore, it is not preferable in terms of high performance.

In order to obtain the effect described above, the upper limit of the conditional formula (13) described above is preferable to be 20.00, 15.00, 12.00, 10.00, 9.00, 8.00, 7.00, 6.00, 5.50, 5.00, 4.50, 4.00, 3.50, 3.20, 3.00, 2.80, 2.60, 2.40, and 2.20, in this order. The lower limit of the conditional formula (13) described above is preferable to be 0.22, 0.24, 0.26, 0.28, 0.30, 0.32, 0.34, 0.36, 0.38, 0.40, 0.42, 0.44, 0.46, 0.48, 0.50, 0.52, 0.54, 0.56, 0.58, and 0.60, in this order.

### 1-2-14. Conditional Formula (14)

It is preferable that the optical system satisfies the following conditional formula:

$$1.9 < \vert ff \vert / fR < 1000. , \qquad ( 14 )$$

here,
ff is a focal length of the front group, and
fR is a focal length of the rear group.

The conditional formula (14) described above is a formula for defining the ratio of the focal length of the front group to the focal length of the rear group. In a case where the conditional formula (14) is satisfied, the power arrangement of the front group and the rear group is appropriate, and a large aperture can be obtained and the number of lens pieces can be optimized. That is, it is facilitated to achieve both a large aperture and low cost.

In contrast, when the value of conditional formula (14) is equal to or greater than the upper limit, the refractive power of the rear group becomes too strong, resulting in difficulty in aberration correction without increasing the number of pieces of lenses in the rear group, which is not preferable in terms of achieving both low cost and high performance. When the value of conditional formula (14) is equal to or less than the lower limit, the refractive power of the rear group becomes too weak, which is not preferable in terms of the large aperture.

In order to obtain the effect described above, the upper limit of the conditional formula (14) described above is preferable to be 800.00, 600.00, 400.00, 200.00, 120.00, 100.00, 75.00, 65.00, 50.00, 45.00, 42.00, 40.00, 38.00, and 36.00, in this order. The lower limit of the conditional formula (14) described above is preferable to be 1.95, 2.00, 2.05, 2.10, 2.15, 2.20, 2.25, 2.30, 2.40, and 2.45, in this order.

### 1-2-15. Conditional Formula (15)

It is preferable that the optical system satisfies the following conditional formula:

$$- 0.89 < FLB / FLA < - 0.2 , \qquad ( 15 )$$

here,
FLA is a focal length of the lens A, and
FLB is a focal length of the lens B.

The conditional formula (15) described above is a formula that defines the ratio of the focal length of the lens A to the focal length of the lens B. In a case where the conditional formula (15) is satisfied, a telephoto type power arrangement is likely obtained, and therefore a compact optical system in the overall optical length direction can be achieved. Excessive compactness, however, makes aberration correction difficult and leads to deterioration of error sensitivity. Therefore, there is an appropriate range for the ratio of the focal length of the lens A to the focal length of the lens B. Here, in a case where the conditional formula (15) is satisfied, an optical system having both compactness and lightweighting, and high performance can be achieved.

In contrast, when the value of the conditional formula (15) described above is equal to or greater than the upper limit, the ratio of the focal length of the lens B to the focal length of the lens A becomes large, and the power arrangement of the telephoto becomes weak. In this case, the overall optical length relative to the focal length becomes too large, and the weight, including the mechanical structure, becomes heavy, which is not preferable in terms of lightweighting. When the value of the conditional formula (15) described above is equal to or less than the lower limit, the ratio of the focal length of the lens B to the focal length of the lens A becomes small, and the magnification action at the lens on the most image side becomes relatively large. Such a case is not preferable in terms of high performance since the aberration magnification action on the image side of the optical system becomes large.

In order to obtain the effect described above, the upper limit of the conditional formula (15) described above is preferable to be −0.21, −0.22, −0.23, −0.24, and −0.25, in this order. The lower limit of the conditional formula (15) described above is preferable to be −0.87, −0.85, −0.83, −0.81, −0.79, −0.77, −0.75, −0.73, −0.71, −0.69, −0.67, −0.65, −0.63, −0.61, −0.59, −0.57, and −0.55, in this order.

### 1-2-16. Conditional Formula (16)

It is preferable that the optical system satisfies the following conditional formula:

$$0.3 < TLAS / TLSB < 0.92 , \qquad ( 16 )$$

here,
TLAS is a distance from an object side surface of the lens A to the stop, and
TLSB is a distance from the stop to an image side surface of the lens B.

The conditional formula (16) described above is a formula for defining the ratio of the distance from the object side surface of the lens A to the stop, to the distance from the stop to the image side surface of the lens B. In a case where the conditional formula (16) is satisfied, the position of the stop relative to the lens A on the most object side and the lens B on the most image side is appropriate, and therefore the diameter of the lens A and the diameter of the lens B can be both compact. Avoiding a large lens diameter leads to reduced volume of the lenses, thus achieving a lightweight lens.

On the other hand, when the value of the conditional formula (16) described above is equal to or greater than the upper limit, the position of the stop relative to the lens A on the most object side and the lens B on the most image side becomes close to the lens B. This increases the diameter of the lens A, resulting in a large volume of the lens A, heavy weight, and increased cost, which is not preferable in terms of lightweighting and low cost. When the value of the conditional formula (16) described above is equal to or less than the lower limit, the position of the stop relative to the lens A on the most object side and the lens B on the most image side becomes close to the lens A. This increases the diameter of the lens B, resulting in a large volume of the lens B, heavy weight, and increased cost, which is not preferable in terms of lightweighting and low cost.

In order to obtain the effect described above, the upper limit of the conditional formula (16) described above is preferable to be 0.91, 0.90, 0.89, 0.88, 0.87, 0.86, 0.85, 0.84, 0.83, and 0.82, in this order. The lower limit of the conditional formula (16) described above is preferable to be 0.31, 0.32, 0.33, 0.34, 0.35, 0.36, and 0.37, in this order.

### 1-2-17. Conditional Formula (17)

It is preferable that the optical system satisfies the following conditional formula:

$$- 4.5 < CRBf / BF < - 1.2 , \qquad ( 17 )$$

here,
CRBf is a curvature radius of an object side surface of the lens B, and
BF is an air-equivalent distance from a lens surface on a most image side of the rear group to an image plane.

The conditional formula (17) described above is a formula for defining the shape of the object side surface of the lens B on the most image side of the rear group. In a case where the ratio of the object side surface curvature radius of the lens B on the most image side of the rear group to the air-equivalent distance from the lens surface on the most image side of the rear group to the image plane satisfies the conditional formula (17) described above, coma aberration can be corrected favorably, and an optical system having high image formation performance can be realized. In the case of a so-called composite aspherical lens with an aspherical film attached to a lens unit having a positive refractive power arranged on the most object side, CRBf is the curvature radius of the base lens, not the curvature radius of the aspherical film.

In contrast, when the value of the conditional formula (17) is equal to or less than the lower limit, the curvature radius of the object side surface of the lens B on the most image side becomes large, and the correction amount of coma aberration becomes small, which is not preferable in terms of high performance. When the value of conditional formula (17) is equal to or greater than the upper limit, the curvature radius of the object side surface of the lens B on the most image side becomes small, and the generation amount of coma aberration becomes large, which is not preferable in terms of high performance.

In order to obtain the effect described above, the upper limit of the conditional formula (17) described above is preferable to be −1.24, −1.26, −1.28, −1.30, −1.32, −1.34, −1.36, −1.38, −1.40, −1.42, −1.44, and −1.46, in this order. The lower limit of the conditional formula (17) described above is preferable to be −4.45, −4.40, −4.35, −4.30, −4.25. −4.20, −4.15, −4.10, and −4.05, in this order.

### 1-2-18. Conditional Formula (18)

It is preferable that the optical system satisfies the following conditional formula:

$$0.3 < ν dLA / ν dLB < 3. , \qquad ( 18 )$$

here,
νdLA is an Abbe constant at d-line of the lens A, and
νdLB is an Abbe constant at d-line of the lens B.

The conditional formula (18) described above is a formula for defining the ratio of the Abbe constant at d-line of the lens A to the Abbe constant at d-line of the lens B. In a case where the conditional formula (18) is satisfied, both axial chromatic aberration and lateral chromatic aberration are corrected and high performance is achieved.

In contrast, when the value of the conditional formula (18) is equal to or less than the lower limit, the Abbe constant at d-line of the lens A becomes too small, resulting in difficulty in correction of axial chromatic aberration, which is not preferable in terms of high performance. When the value of the conditional formula (18) is equal to or greater than the upper limit, the Abbe constant at d-line of the lens B becomes too small, resulting in difficulty in correction of lateral chromatic aberration, which is not preferable in terms of high performance.

In order to obtain the effect described above, the upper limit of the conditional formula (18) described above is preferable to be 2.90, 2.80, 2.70, 2.60, 2.50, 2.40, 2.30, 2.20, 2.10, 2.00, 1.90, and 1.85, in this order. The lower limit of the conditional formula (18) described above is preferable to be 0.35, 0.40, 0.45, 0.50, 0.55, 0.60, 0.65, 0.70, 0.75, 0.80, 0.85, 0.90, 0.95, and 0.99, in this order.

### 1-2-19. Conditional Formula (19)

It is preferable that the optical system satisfies the following conditional formula:

$$1. < TTL / f < 3.5 , \qquad ( 19 )$$

here,
TTL is a distance from a lens surface on a most object side of the front group to an image plane, and
f is a focal length of the optical system.

The conditional formula (19) described above is a formula that defines the ratio of the overall optical length to the focal length of the optical system. Reducing the overall optical length relative to the focal length makes aberration correction difficult and leads to deterioration of error sensitivity. When the overall optical length relative to the focal length becomes too large, the weight, including the mechanical structure, becomes heavy, and therefore there is an appropriate range for the ratio of the overall length to the focal length. Here, in a case where the conditional formula (19) is satisfied, an optical system having both compactness and lightweighting, and high performance can be achieved.

In contrast, when the value of the conditional formula (19) described above is equal to or greater than the upper limit, the overall optical length relative to the focal length becomes too large, and the weight, including the mechanical structure, becomes heavy, which is not preferable in terms of lightweighting. When the value of the conditional formula (19) described above is equal to or less than the lower limit, the overall optical length relative to the focal length becomes too small, and a large number of lens pieces become necessary for aberration correction, which is not preferable in terms of cost. Furthermore, it leads to deterioration in manufacturability, which is not preferable in terms of high performance.

In order to obtain the effect described above, the upper limit of the conditional formula (19) described above is preferable to be 3.40, 3.30, 3.20, 3.10, 3.00, 2.90, 2.80, 2.70, 2.60, 2.50, 2.40, 2.30, 2.20, 2.10, and 2.00, in this order. The lower limit of the conditional formula (19) described above is preferable to be 1.02, 1.04, 1.06, 1.08, 1.10, 1.12, and 1.13, in this order.

### 2. Imaging Apparatus and Moving Body

Next, an imaging device according to the present invention will be described. The imaging device according to the present invention includes the optical system according to the present invention, and an image sensor that receives an optical image formed by the optical system and converts the optical image into an electrical image signal.

Here, the image sensor is not particularly limited, and a solid-state image sensor such as a charge-coupled device (CCD) sensor or a complementary metal oxide semiconductor (CMOS) sensor can also be used. The imaging device according to the present invention is suitable for imaging device using these solid-state image sensors, such as a digital camera, a video camera, a surveillance camera, an in-vehicle camera, a camera for drones, a camera for medical use, and the like. The imaging device may be a fixed-lens imaging device in which the lens is fixed to the housing, or may be a lens-interchangeable imaging device such as a single-lens reflex camera or a mirrorless single-lens camera. In particular, since the optical system according to the present invention is compact, it is suitable for the imaging device mounted on a moving body of a vehicle, a drone, or the like.

It is more preferable that the imaging device and the moving body of the present invention have an image processing unit that electrically processes the captured image data acquired by the image sensor to change the shape of the captured image, and an image correction data storage unit that stores image correction data, an image correction program, and the like, used to process the captured image data in the image processing unit. In a case where the optical system is made compact, distortion (skewness) of the captured image shape formed on an image forming surface becomes likely to occur. In this case, it is preferable to store in advance distortion correction data for correcting the distortion of the captured image shape in the image correction data storage unit, and to correct the distortion of the captured image shape in the image processing unit using the distortion correction data stored in the image correction data storage unit. According to such an imaging device, the optical system can be achieved even more compact, and not only can a clear captured image be obtained, but the entire imaging device can be achieved compact.

It is preferable that the imaging device and the moving body of the present invention store in advance lateral chromatic aberration correction data in the image correction data storage unit, and cause the image processing unit to perform lateral chromatic aberration correction on the captured image using the lateral chromatic aberration correction data stored in the image correction data storage unit. By correcting lateral chromatic aberration, that is, color distortion, using the image processing unit, it is possible to reduce the number of lens pieces of the optical system. Therefore, according to such an imaging device, the optical system can be achieved even more compact, and not only can a clear captured image be obtained, but the entire imaging device can be achieved compact.

Next, the present invention will be specifically described with reference to examples. However, the present invention is not limited to the following examples. In each lens cross-sectional view, the left side is the object side and the right side is the image side as viewed in the drawing.

### Example 1

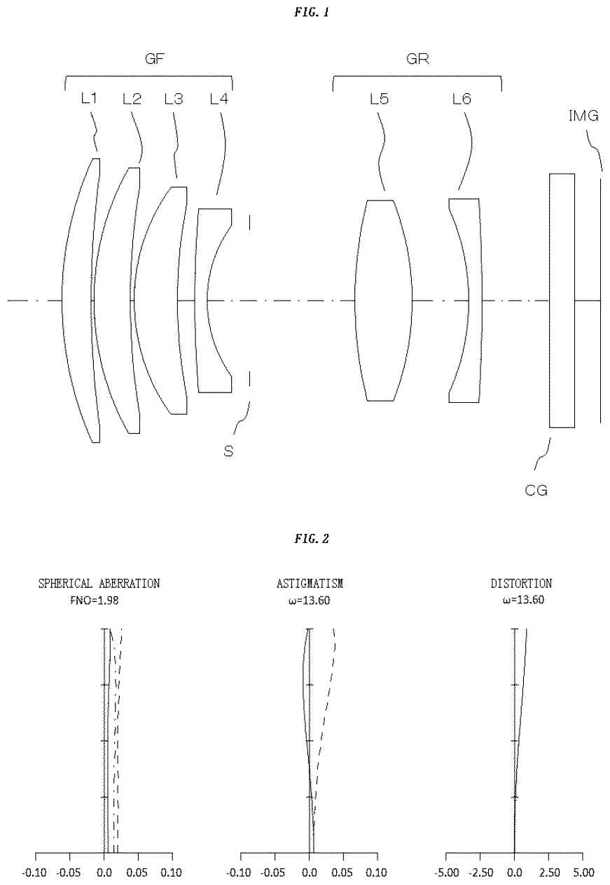

FIG. 1 is a lens cross-sectional view illustrating a configuration of an optical system of Example 1 according to the present invention. The optical system includes, in order from the object side, a front group GF having a positive refractive power, a stop, and a rear group GR having a positive refractive power.

The front group GF having a positive refractive power includes, in order from the object side, a positive meniscus lens L1 with a convex shape toward the object side, a positive meniscus lens L2 with a convex shape toward the object side, a positive meniscus lens L3 with a convex shape toward the object side, and a negative meniscus lens L4 with a convex shape toward the object side. Here, the positive meniscus lens L1 with a convex shape toward the object side corresponds to the lens A of the present invention.

The rear group GR having a positive refractive power includes, in order from the object side, a biconvex lens L5 having a positive refractive power with both the object side surface and the image side surface being convex surfaces, and a negative meniscus lens L6 having a concave shape toward the object side. Here, the negative meniscus lens L6 with a concave shape toward the object side corresponds to the lens B of the present invention.

Note that “IMG” in the figure indicates the image plane. It is the imaging surface of a solid-state image sensor, such as a CCD or CMOS sensor, as described above. Light incident from the object side of the optical system forms an image on the image plane. The solid-state image sensor converts the received optical image into an electrical image signal. The image processing unit (image processor, or the like) of the imaging device or the like generates a digital image corresponding to the image of the subject based on the electrical image signal output from the image sensor. The digital image can be recorded on a recording medium such as a hard disk drive (HDD), a memory card, an optical disk, or a magnetic tape, for example. Note that the image plane may be a film surface of a silver halide film.

In addition, “CG” in the figure indicates an optical block. The optical block CG is equivalent to an optical filter, a cover glass, a crystal low-pass filter, an infrared cut filter, and the like. Since these symbols (IMG, CG) are similar in each of the figures illustrated in other examples, the description thereof will be omitted below.

### Example 2

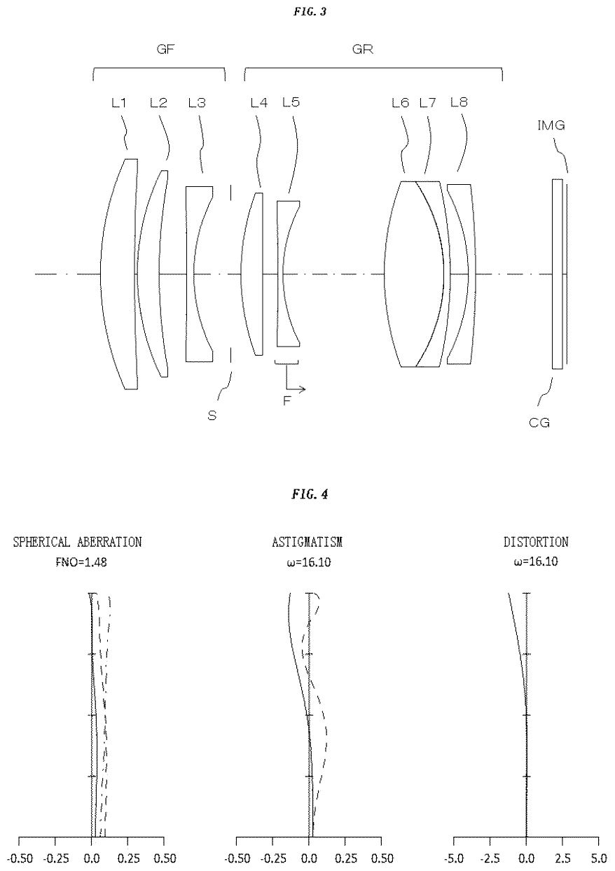

FIG. 3 is a lens cross-sectional view illustrating a configuration of an optical system of Example 2 according to the present invention. The optical system includes, in order from the object side, a front group GF having a positive refractive power, a stop, and a rear group GR having a positive refractive power.

The front group GF having a positive refractive power includes, in order from the object side, a positive meniscus lens L1 with a convex shape toward the object side, a positive meniscus lens L2 with a convex shape toward the object side, and a biconcave lens L3 having a negative refractive power with both the object side surface and the image side surface being concave surfaces. Here, the positive meniscus lens L1 with a convex shape toward the object side corresponds to the lens A of the present invention.

The rear group GR having a positive refractive power includes, in order from the object side, a positive meniscus lens L4 with a convex shape toward the object side, a biconcave lens L5 having a negative refractive power with both the object side surface and the image side surface being concave surfaces, a bonded lens consisting of a biconvex lens L6 having a positive refractive power with both the object side surface and the image side surface being convex surfaces and a negative meniscus lens L7 with a concave shape toward the object side, and a negative meniscus lens L8 with a concave shape toward the object side. Here, the negative meniscus lens L8 with a concave shape toward the object side corresponds to the lens B of the present invention.

Here, the biconcave lens L5 having a negative refractive power with both the object side surface and the image side surface being concave surfaces corresponds to a focus group in which the focusing from the infinity object to the finite distance object is performed by moving the focus group to the image side.

### Example 3

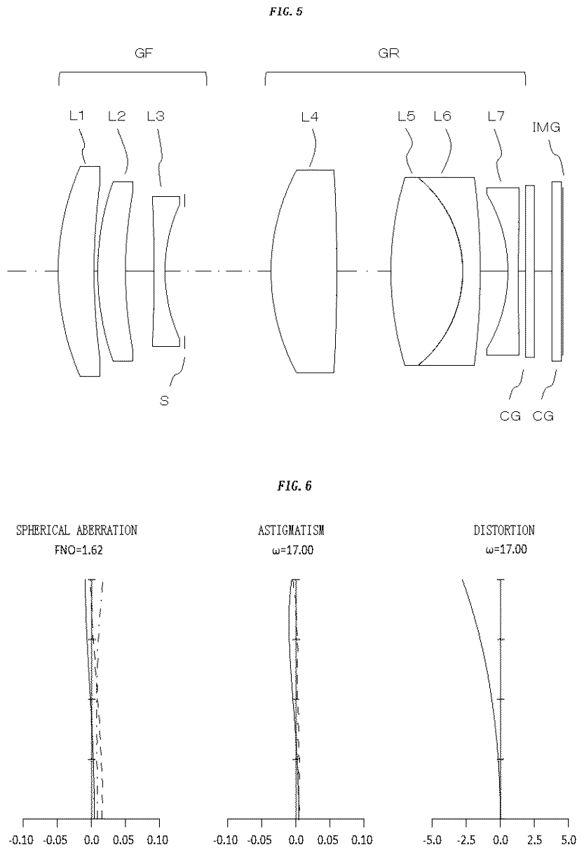

FIG. 5 is a cross-sectional view lens illustrating a configuration of an optical system of Example 3 according to the present invention. The optical system includes, in order from the object side, a front group GF having a negative refractive power, a stop, and a rear group GR having a positive refractive power.

The front group GF having a negative refractive power includes, in order from the object side, a positive meniscus lens L1 with a convex shape toward the object side, a positive meniscus lens L2 with a convex shape toward the object side, and a biconcave lens L3 having a negative refractive power with both the object side surface and the image side surface being concave surfaces. Here, the positive meniscus lens L1 with a convex shape toward the object side corresponds to the lens A of the present invention.

The rear group GR having a positive refractive power includes, in order from the object side, a biconvex lens L4 having a positive refractive power with both the object side surface and the image side surface being convex surfaces, a bonded lens consisting of a biconvex lens L5 having a positive refractive power with both the object side surface and the image side surface being convex surfaces and a negative meniscus lens L6 with a concave shape toward the object side, and a biconcave lens L7 having a negative refractive power with both the object side surface and the image side surface being concave surfaces. Here, the biconcave lens L7 having a negative refractive power with both the object side surface and the image side surface being concave surfaces corresponds to the lens B of the present invention.

### Example 4

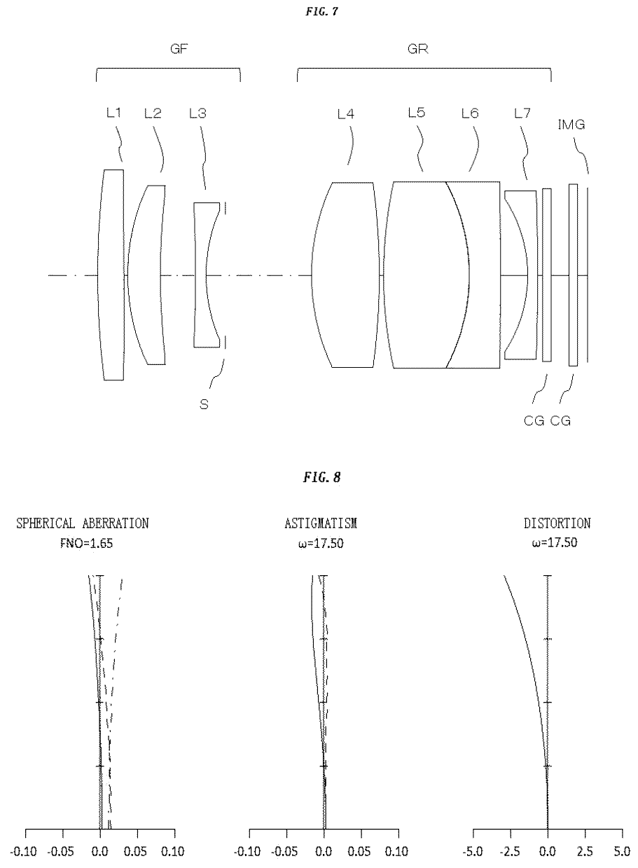

FIG. 7 is a lens cross-sectional view illustrating a configuration of an optical system of Example 4 according to the present invention. The optical system includes, in order from the object side, a front group GF having a positive refractive power, a stop, and a rear group GR having a positive refractive power.

The front group GF having a positive refractive power includes, in order from the object side, a biconvex lens L1 having a positive refractive power with both the object side surface and the image side surface being convex surfaces, a positive meniscus lens L2 with a convex shape toward the object side, and a biconcave lens L3 having a negative refractive power with both the object side surface and the image side surface being concave surfaces. Here, the biconvex lens L1 having a positive refractive power with both the object side surface and the image side surface being convex surfaces corresponds to the lens A of the present invention.

The rear group GR having a positive refractive power includes, in order from the object side, a biconvex lens L4 having a positive refractive power with both the object side surface and the image side surface being convex surfaces, a bonded lens consisting of a biconvex lens L5 having a positive refractive power with both the object side surface and the image side surface being convex surfaces and a negative meniscus lens L6 with a concave shape toward the object side, and a negative meniscus lens L7 with a concave shape toward the object side. Here, the negative meniscus lens L7 with a concave shape toward the object side corresponds to the lens B of the present invention.

### Example 5

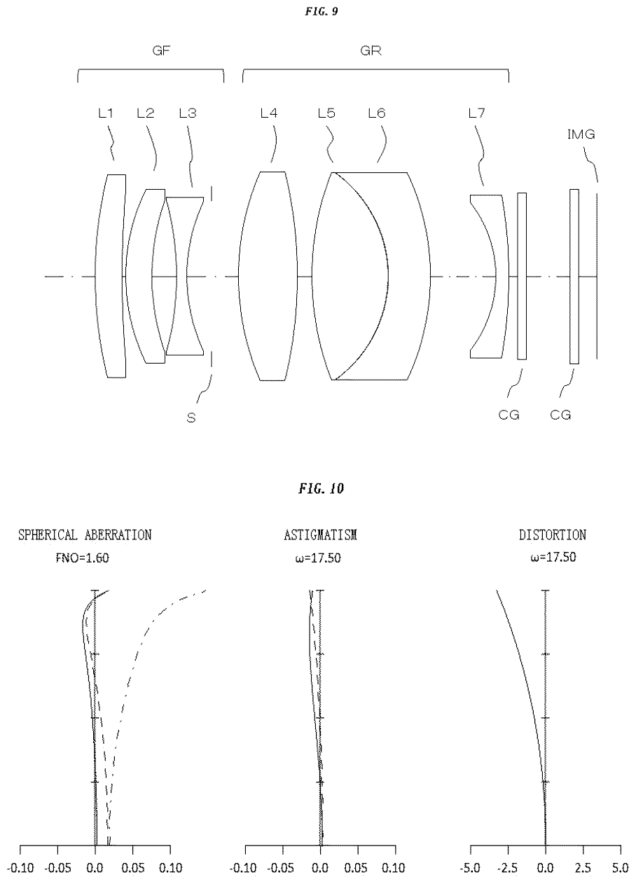

FIG. 9 is a lens cross-sectional view illustrating a configuration of an optical system of Example 5 according to the present invention. The optical system includes, in order from the object side, a front group GF having a negative refractive power, a stop, and a rear group GR having a positive refractive power.

The front group GF having a negative refractive power includes, in order from the object side, a positive meniscus lens L1 with a convex shape toward the object side, a positive meniscus lens L2 with a convex shape toward the object side, and a biconcave lens L3 having a negative refractive power with both the object side surface and the image side surface being concave surfaces. Here, the positive meniscus lens L1 with a convex shape toward the object side corresponds to the lens A of the present invention.

The rear group GR having a positive refractive power includes, in order from the object side, a biconvex lens L4 having a positive refractive power with both the object side surface and the image side surface being convex surfaces, a bonded lens consisting of a biconvex lens L5 having a positive refractive power with both the object side surface and the image side surface being convex surfaces and a negative meniscus lens L6 with a concave shape toward the object side, and a negative meniscus lens L7 with a concave shape toward the object side. Here, the negative meniscus lens L7 with a concave shape toward the object side corresponds to the lens B of the present invention.

The longitudinal aberration diagrams of the optical system at infinity focusing state are illustrated below. The longitudinal aberration diagrams are, in order from the left side of the drawing, spherical aberration (mm), astigmatism (mm), and distortion (%). In a diagram illustrating spherical aberration, the vertical axis represents the maximum aperture (F-number). The solid line illustrates spherical aberration at d-line (wavelength 587.56 nm), the dotted line illustrates spherical aberration at C-line (wavelength 656.27 nm), and the dash-dot line illustrates spherical aberration at g-line (wavelength 435.84 nm). In a diagram illustrating astigmatism, the vertical axis represents the image height (mm). The solid line illustrates the sagittal direction at d-line (wavelength 587.56 nm), and the dotted line illustrates the meridional direction at d-line. In a diagram illustrating distortion, the vertical axis represents the image height (mm) and the distortion (%) at d-line (wavelength: 587.56 nm) is illustrated.

The following are numerical examples 1 to 5, corresponding to Examples 1 to 5, respectively. In the surface data of each numerical example, “surface number” represents the lens surface number counted in order from the object side, “r” represents the curvature radius of the lens surface (mm) (here, a surface with an r value of 0.0000 indicates that the surface is flat), “d” represents the interval (mm) of the lens surfaces on the optical axis between the i-th lens surface (i is a natural number) and the (i+1)-th lens surface from the object side, “Nd” represents the refractive index with respect to d-line (wavelength λ=587.56 nm), “νd” represents the Abbe constant with respect to d-line, and “h” represents the effective radius (mm).

Note that in each numerical example, the focal length (mm), the F-number (F value), the half angle of view (°), the image height (mm), the overall lens length (mm), and the back focus (BF (in air)) (mm) of the imaging lens are illustrated. Here, the overall lens length is the distance on the optical axis from the object side surface of the first lens to the image plane. The back focus is the air equivalent value of the distance on the optical axis from the image side surface of the n-th lens arranged on the most image side to the image plane.

In a case where the optical surface is an aspherical surface, a symbol * is denoted on the right side of the surface number. Note that the aspherical coefficient can be represented by the following aspherical formula, where the displacement amount Z in the optical axis direction at the position of height h from the optical axis is used as the surface apex reference:

$$Z = {ch}^{2} / [ 1 + {\{ 1 - ( 1 + k ) {c}^{2} {h}^{2} \}}^{1 / 2} ] + A 4 {h}^{4} + A 6 {h}^{6} + A 8 {h}^{8} + A 10 {h}^{10} + … ,$$

here, c is the curvature (1/r), h is the height from the optical axis, k is the cone coefficient (conic constant), A4, A6, A8, A10, . . . are the aspherical coefficients of each order. The notation “E±m” (m represents an integer) in the numerical values of the aspherical coefficient and the conic constant refers to “×10^{±m}”.

The aperture stop is denoted by the symbol S on the right side of the surface number.

The interval that changes during focusing is denoted by the symbol “d” on the left side of the interval number. The interval data indicates the variable interval of the optical system.

The lens focal length indicates the focal length of each lens of the optical system.

The lens group focal length indicates the focal length of each lens group of the optical system.

### Numerical Example 1

### Surface Data

| Surface | | | | | |
|---|---|---|---|---|---|
| number | r | d | Nd | vd | h |
| 1 | 11.8115 | 1.163 | 1.76250 | 51.90 | 4.750 |
| 2 | 34.7231 | 0.100 | | | 4.652 |
| 3 | 9.3481 | 1.410 | 1.49700 | 81.61 | 4.420 |
| 4 | 22.7879 | 0.170 | | | 4.183 |
| 5 | 6.7710 | 1.688 | 1.49700 | 81.61 | 3.789 |
| 6 | 18.0838 | 0.657 | | | 3.384 |
| 7 | 34.5707 | 0.490 | 1.90366 | 31.31 | 3.074 |
| 8 | 4.5480 | 1.666 | | | 2.650 |
| 9S | 0.0000 | 4.115 | | | 2.600 |
| 10 | 14.2002 | 2.240 | 1.75666 | 43.30 | 3.200 |
| 11 | −9.6258 | 2.195 | | | 3.353 |
| 12 | −7.7717 | 0.520 | 1.80610 | 33.27 | 3.210 |
| 13 | −63.4644 | 2.641 | | | 3.391 |
| 14 | 0.0000 | 1.000 | 1.51680 | 64.20 | 4.081 |
| 15 | 0.0000 | 1.006 | | | 4.244 |

| | |
|---|---|
| Focal length | 18.441 |
| F-number | 1.976 |
| Half angle of view | 13.604 |
| Image height | 4.500 |
| Overall lens | 21.055 |
| BF | 4.300 |

### Lens Focal Length

| Lens | Surface number | Focal length |
|---|---|---|
| L1 | 1-2 | 22.972 |
| L2 | 3-4 | 30.819 |
| L3 | 5-6 | 20.750 |
| L4 | 7-8 | −5.841 |
| L5 | 10-11 | 7.902 |
| L6 | 11-12 | −11.032 |

### Lens Group Focal Length

| Group | Surface number | Focal length |
|---|---|---|
| GF | 1-8 | 52.719 |
| GR | 10-13 | 14.974 |

### Numerical Example 2

### Surface Data

| Surface | | | | | |
|---|---|---|---|---|---|
| number | r | d | Nd | vd | h |
| 1 | 67.9170 | 8.400 | 1.90109 | 42.85 | 26.500 |
| 2 | 605.0464 | 0.626 | | | 25.719 |
| 3 | 57.7434 | 5.238 | 1.75002 | 58.39 | 23.682 |
| 4 | 123.4468 | 6.739 | | | 22.741 |
| 5 | −911.5790 | 1.800 | 1.84666 | 23.78 | 20.068 |
| 6 | 41.5245 | 9.001 | | | 18.368 |
| 7S | 0.0000 | 2.508 | | | 18.000 |
| 8 | 57.6803 | 5.163 | 1.80420 | 46.50 | 18.432 |
| 9 | 8704.3538 | d9 | | | 18.296 |
| 10 | −941.887 | 1.297 | 1.48749 | 70.44 | 16.500 |
| 11* | 35.8899 | d11 | | | 16.500 |
| 12 | 0.0000 | 4.570 | | | 17.000 |
| 13 | 66.3026 | 14.412 | 1.99680 | 42.77 | 21.030 |
| 14 | −40.6808 | 1.700 | 1.59270 | 35.45 | 21.234 |
| 15 | −97.2186 | 4.313 | | | 20.645 |
| 16* | −42.8945 | 1.850 | 1.84666 | 23.78 | 20.500 |
| 17 | −197.4151 | 18.619 | | | 20.553 |
| 18 | 0.0000 | 2.500 | 1.51633 | 64.15 | 21.582 |
| 19 | 0.0000 | d19 | | | 21.668 |

### Aspherical Data

| Surface number | 11 | 16 |
|---|---|---|
| k | 0.00000E+00 | 0.00000E+00 |
| A4 | 3.24697E−07 | −5.10314E−07 |
| A6 | −3.57689E−09 | 6.84468E−09 |
| A8 | 1.79819E−11 | −1.48313E−11 |
| A10 | −2.44845E−14 | 1.23711E−14 |

| | |
|---|---|
| Focal length | 75.907 |
| F-number | 1.476 |
| Half angle of view | 16.098 |
| Image height | 21.630 |
| Overall lens | 113.557 |
| BF | 21.268 |

### Variable Interval Data

| | | | |
|---|---|---|---|
| d0 | INF | 2400.433 | 636.565 |
| d9 | 3.684 | 6.673 | 15.990 |
| d11 | 20.137 | 17.148 | 7.833 |
| d19 | 1.025 | 1.034 | 1.163 |

### Lens Focal Length

| Lens | Surface number | Focal length |
|---|---|---|
| L1 | 1-2 | 84.278 |
| L2 | 3-4 | 139.872 |
| L3 | 5-6 | −46.868 |
| L4 | 8-9 | 72.183 |
| L5 | 10-11 | −70.889 |
| L6 | 13-14 | 27.116 |
| L7 | 14-15 | −119.358 |
| L8 | 16-17 | −65.084 |

### Lens Group Focal Length

| Group | Surface number | Focal length |
|---|---|---|
| GF | 1-6 | 291.249 |
| GR | 8-17 | 60.239 |

### Numerical Example 3

### Surface Data

| Surface | | | | | |
|---|---|---|---|---|---|
| number | r | d | Nd | vd | h |
| 1 | 14.9283 | 2.000 | 1.80420 | 46.50 | 5.327 |
| 2 | 37.4558 | 0.200 | | | 4.873 |
| 3 | 14.8826 | 1.560 | 1.80100 | 49.35 | 4.555 |
| 4 | 25.9267 | 1.600 | | | 4.226 |
| 5 | −74.7966 | 0.600 | 1.66083 | 25.44 | 3.819 |
| 6 | 9.0588 | 1.090 | | | 3.588 |
| 7S | 0.0000 | 4.823 | | | 3.600 |
| 8 | 11.8228 | 3.698 | 1.84796 | 42.67 | 5.155 |
| 9 | −95.0613 | 3.030 | | | 5.109 |
| 10 | 18.2705 | 3.990 | 1.74443 | 49.26 | 4.798 |
| 11 | −6.8304 | 1.000 | 1.85451 | 25.15 | 4.535 |
| 12 | −40.6708 | 1.541 | | | 4.308 |
| 13 | −8.5200 | 0.600 | 1.71048 | 32.52 | 4.115 |
| 14 | 1001.8088 | 0.380 | | | 4.258 |
| 15 | 0.0000 | 0.500 | 1.56883 | 56.04 | 4.314 |
| 16 | 0.0000 | 1.000 | | | 4.361 |
| 17 | 0.0000 | 0.500 | 1.56883 | 56.04 | 4.512 |
| 18 | 0.0000 | 0.112 | | | 4.559 |

| | |
|---|---|
| Focal length | 15.393 |
| F-number | 1.624 |
| Half angle of view | 17.000 |
| Image height | 4.702 |
| Overall lens | 27.856 |
| BF | 2.125 |

### Lens Focal Length

| Lens | Surface number | Focal length |
|---|---|---|
| L1 | 1-2 | 29.442 |
| L2 | 3-4 | 40.714 |
| L3 | 5-6 | −12.012 |
| L4 | 8-9 | 12.490 |
| L5 | 10-11 | 7.112 |
| L6 | 11-12 | −9.595 |
| L7 | 13-14 | −11.750 |

### Lens Group Focal Length

| Group | Surface number | Focal length |
|---|---|---|
| GF | 1-6 | −218.480 |
| GR | 8-14 | 10.836 |

### Numerical Example 4

### Surface Data

| Surface | | | | | |
|---|---|---|---|---|---|
| number | r | d | Nd | vd | h |
| 1 | 42.0621 | 1.533 | 1.80420 | 46.50 | 5.296 |
| 2 | −1655.6058 | 0.220 | | | 5.024 |
| 3 | 11.1051 | 1.897 | 1.77250 | 49.62 | 4.500 |
| 4 | 33.3982 | 2.069 | | | 4.201 |
| 5 | −88.8186 | 0.600 | 1.69895 | 30.05 | 3.627 |
| 6 | 8.6361 | 1.108 | | | 3.393 |
| 7S | 0.0000 | 5.017 | | | 3.394 |
| 8 | 11.5135 | 3.987 | 1.61800 | 63.39 | 4.450 |
| 9 | −32.7094 | 0.220 | | | 4.671 |
| 10 | 23.7072 | 5.000 | 1.88100 | 40.14 | 4.714 |
| 11 | −10.3589 | 1.794 | 1.75211 | 25.05 | 4.457 |
| 12 | −840.8044 | 1.583 | | | 4.133 |
| 13 | −7.4582 | 0.600 | 1.59270 | 35.45 | 4.050 |
| 14 | −152.2476 | 0.300 | | | 4.253 |
| 15 | 0.0000 | 0.500 | 1.51680 | 64.20 | 4.314 |
| 16 | 0.0000 | 1.000 | | | 4.370 |
| 17 | 0.0000 | 0.500 | 1.51680 | 64.20 | 4.541 |
| 18 | 0.0000 | 0.607 | | | 4.596 |

| | |
|---|---|
| Focal length | 15.372 |
| F-number | 1.648 |
| Half angle of view | 17.500 |
| Image height | 4.847 |
| Overall lens | 28.534 |
| BF | 2.566 |

### Lens Focal Length

| Lens | Surface number | Focal length |
|---|---|---|
| L1 | 1-2 | 50.613 |
| L2 | 3-4 | 20.605 |
| L3 | 5-6 | −11.092 |
| L4 | 8-9 | 14.188 |
| L5 | 10-11 | 8.707 |
| L6 | 11-12 | −13.749 |
| L7 | 13-14 | −13.111 |

### Lens Group Focal Length

| Group | Surface number | Focal length |
|---|---|---|
| GF | 1-6 | 388.055 |
| GR | 8-14 | 11.464 |

### Numerical Example 5

### Surface Data

| Surface | | | | | |
|---|---|---|---|---|---|
| number | r | d | Nd | vd | h |
| 1 | 24.1852 | 1.602 | 1.81080 | 46.50 | 5.434 |
| 2 | 65.0858 | 0.200 | | | 5.106 |
| 3 | 11.3761 | 1.560 | 1.89126 | 40.80 | 4.650 |
| 4 | 13.9166 | 1.420 | | | 4.287 |
| 5 | −17.5996 | 0.600 | 1.73902 | 32.23 | 4.226 |
| 6 | 10.4013 | 1.474 | | | 4.202 |
| 7S | 0.0000 | 1.566 | | | 4.415 |
| 8 | 15.1455 | 3.464 | 1.89126 | 40.80 | 5.400 |
| 9 | −26.1438 | 0.885 | | | 5.573 |
| 10 | 17.0821 | 4.450 | 1.62172 | 63.39 | 5.529 |
| 11 | −7.4849 | 2.500 | 1.86746 | 25.15 | 5.348 |
| 12 | −14.3048 | 3.833 | | | 5.429 |
| 13 | −7.0976 | 0.797 | 1.69804 | 31.14 | 4.143 |
| 14 | −25.4844 | 0.500 | | | 4.349 |
| 15 | 0.0000 | 0.500 | 1.51680 | 64.20 | 4.417 |
| 16 | 0.0000 | 2.572 | | | 4.442 |
| 17 | 0.0000 | 0.500 | 1.51680 | 64.20 | 4.642 |
| 18 | 0.0000 | 1.077 | | | 4.667 |

| | |
|---|---|
| Focal length | 15.400 |
| F-number | 1.600 |
| Half angle of view | 17.500 |
| Image height | 4.856 |
| Overall lens | 29.499 |
| BF | 4.785 |

### Lens Focal Length

| Lens | Surface number | Focal length |
|---|---|---|
| L1 | 1-2 | 46.649 |
| L2 | 3-4 | 54.231 |
| L3 | 5-6 | −8.767 |
| L4 | 8-9 | 11.203 |
| L5 | 10-11 | 8.996 |
| L6 | 11-12 | −21.812 |
| L7 | 13-14 | −14.349 |

### Lens Group Focal Length

| Group | Surface number | Focal length |
|---|---|---|
| GF | 1-6 | −18.815 |
| GR | 8-14 | 7.619 |

The corresponding values and various values of conditional formulas (1) to (19) in Examples 1 to 5 are listed in Table 1 below.

TABLE 1

| | |
|---|---|
| (1) | NdLB |
| (2) | TLSB/BF |
| (3) | fR/f |
| (4) | FLB/f |
| (5) | νdLA |
| (6) | νdLB |
| (7) | CRBf/f |
| (8) | f/EPD |
| (9) | FLA/f |
| (10) | (CRBf + CRBr)/(CRBf − CRBr) |
| (11) | NdLA |
| (12) | BF/f |
| (13) | CRsz/f |
| (14) | \|ff\|/fR |
| (15) | FLB/FLA |
| (16) | TLAS/TLSB |
| (17) | CRBf/BF |
| (18) | νdLA/νdLB |
| (19) | TTL/f |

| | Example 1 | Example 2 | Example 3 | Example 4 | Example 5 |
|---|---|---|---|---|---|
| (1) | 1.806 | 1.847 | 1.719 | 1.599 | 1.698 |
| (2) | 2.109 | 2.804 | 8.792 | 7.092 | 3.656 |
| (3) | 0.812 | 0.794 | 0.705 | 0.746 | 0.495 |
| (4) | −0.598 | −0.857 | −0.764 | −0.854 | −0.932 |
| (5) | 51.903 | 42.849 | 46.502 | 46.502 | 46.502 |
| (6) | 33.269 | 23.784 | 32.520 | 35.445 | 31.138 |
| (7) | −0.421 | −0.565 | −0.554 | −0.486 | −0.461 |
| (8) | 1.976 | 1.476 | 1.621 | 1.600 | 1.600 |
| (9) | 1.246 | 1.110 | 1.914 | 3.295 | 3.029 |
| (10) | −1.279 | −1.555 | −0.983 | −1.103 | −1.772 |
| (11) | 1.763 | 1.901 | 1.811 | 1.811 | 1.811 |
| (12) | 0.232 | 0.280 | 0.138 | 0.167 | 0.311 |
| (13) | 0.770 | 0.760 | 0.769 | 0.750 | 0.983 |
| (14) | 3.521 | 4.835 | 20.163 | 33.851 | 2.470 |
| (15) | −0.480 | −0.772 | −0.399 | −0.259 | −0.308 |
| (16) | 0.810 | 0.533 | 0.377 | 0.408 | 0.392 |
| (17) | −1.807 | −2.017 | −4.010 | −2.906 | −1.483 |
| (18) | 1.560 | 1.802 | 1.430 | 1.312 | 1.493 |
| (19) | 1.142 | 1.496 | 1.834 | 1.857 | 1.915 |

| | | | | | |
|---|---|---|---|---|---|
| TLSB | 9.070 | 59.634 | 18.681 | 18.201 | 17.494 |
| BF | 4.300 | 21.268 | 2.125 | 2.566 | 4.785 |
| fR | 14.974 | 60.239 | 10.836 | 11.464 | 7.619 |
| f | 18.441 | 75.907 | 15.380 | 15.361 | 15.400 |
| FLB | −11.032 | −65.084 | −11.750 | −13.111 | −14.348 |
| CRBf | −7.772 | −42.895 | −8.520 | −7.458 | −7.098 |
| EPD | 9.334 | 51.432 | 9.491 | 9.600 | 9.625 |
| FLA | 22.972 | 84.278 | 29.442 | 50.613 | 46.649 |
| CRBr | −63.464 | −197.415 | 1001.809 | −152.248 | −25.484 |
| CRsz | 14.200 | 57.680 | 11.823 | 11.513 | 15.146 |
| ff | 52.719 | 291.249 | −218.480 | 388.055 | −18.815 |
| TLAS | 7.344 | 31.804 | 7.050 | 7.427 | 6.856 |
| TTL | 21.055 | 113.557 | 28.211 | 28.527 | 29.499 |

Although the preferred embodiments of the present invention have been described above, the present invention is not limited to these embodiments, and various modifications and changes are possible within the scope of the gist of the present invention.

Furthermore, the following can be considered as another invention to which the present invention is applied. In order to solve the problem described above, an optical system according to the present invention includes, in order from the object side, a front group, a stop, and a rear group, in which the front group has a lens A having a positive refractive power on the most object side, and the rear group has a lens B having a negative refractive power on the most image side, an object side surface of the lens B has a concave surface, and the optical system satisfies following conditional formulas:

$$1.59 < NdLB < 2.3 , and \qquad ( 1 )$$

$$0.1 < BF / f < 0.55 , \qquad ( 12 )$$

here,
NdLB is a refractive index at d-line of the lens B,
BF is an air-equivalent distance from a lens surface on a most image side of the rear group to an image plane, and
f is a focal length of the optical system.

Furthermore, the following can be considered as another invention to which the present invention is applied. In order to solve the problem described above, an optical system according to the present invention includes, in order from the object side, a front group, a stop, and a rear group, in which the front group has a lens A having a positive refractive power on the most object side, and the rear group has a lens B having a negative refractive power on the most image side, an object side surface of the lens B has a concave surface on the object side, and the optical system satisfies following conditional formulas:

$$1.59 < NdLB < 2.3 , and \qquad ( 1 )$$

$$1. < TTL / f < 3.5 , \qquad ( 19 )$$

here,
NdLB is a refractive index at d-line of the lens B,
TTL is a distance from a lens surface on a most object side of the front group to an image plane, and
f is a focal length of the optical system.

According to the present invention, a compact and high-performance optical system, an imaging device and a moving body can be provided.

1. An optical system comprising:
in order from an object side of the optical system,
a front group;
a stop; and
a rear group, wherein
the front group has a lens A having a positive refractive power on a most object side of the front group, and the rear group has a lens B having a negative refractive power on a most image side of the rear group, an object side surface of the lens B has a concave surface on an object side of the lens B, and
the optical system satisfies following conditional formulas:
$$1.59 < NdLB < 2.3 , \qquad ( 1 )$$
$$0.2 < fR / f < 0.9 , \qquad ( 3 - 2 )$$
$$25. < vdLA < 110. , \qquad ( 5 )$$
$$0.18 < BF / f < 0.45 , and \qquad ( 12 - 1 )$$
$$- 0.89 < FLB / FLA < - 0.2 , \qquad ( 15 )$$
here,
NdLB is a refractive index at d-line of the lens B,
fR is a focal length of the rear group,
f is a focal length of the optical system,
vdLA is an Abbe constant at d-line of the lens A,
BF is an air-equivalent distance from a lens surface on a most image side of the rear group to an image plane,
f is a focal length of the optical system,
FLA is a focal length of the lens A, and
FLB is a focal length of the lens B.

2. An optical system comprising:
in order from an object side of the optical system,
a front group;
a stop; and
a rear group, wherein
the front group has a lens A having a positive refractive power on a most object side of the front group, and the rear group has a lens B having a negative refractive power on a most image side of the rear group, an object side surface of the lens B has a concave surface on an object side of the lens B, and
the optical system satisfies following conditional formulas:
$$1.63 < NdLB < 2.3 , \qquad ( 1 - 1 )$$
$$0.2 < fR / f < 0.9 , \qquad ( 3 - 2 )$$
$$- 0.83 < FLB / FLA < - 0.2 , and \qquad ( 15 - 1 )$$
$$0.2 < CRsz / f < 25. , \qquad ( 13 )$$
here,
NdLB is a refractive index at d-line of the lens B,
fR is a focal length of the rear group,
f is a focal length of the optical system,
FLA is a focal length of the lens A,
FLB is a focal length of the lens B, and
CRsz is a curvature radius of a lens surface on an image side of the stop.

3. The optical system according to claim 1 satisfying a following conditional formula:
$$0.2 < CRsz / f < 25. , \qquad ( 13 )$$
here,
CRsz is a curvature radius of a surface on an image side of the stop.

4. The optical system according to claim 2 satisfying a following conditional formula:
$$25. < vdLA < 110. , \qquad ( 5 )$$
here,
vdLA is an Abbe constant at d-line of the lens A.

5. The optical system according to claim 2 satisfying a following conditional formula:
$$0.1 < BF / f < 0.55 , \qquad ( 12 )$$
here,
BF is an air-equivalent distance from a lens surface on a most image side of the rear group to an image plane.

6. The optical system according to claim 1 satisfying a following conditional formula:
$$1.6 < TLSB / BF < 10. , \qquad ( 2 )$$
here,
TLSB is a distance from the stop to an image side surface of the lens B, and
BF is an air-equivalent distance from a lens surface on a most image side of the rear group to an image plane.

7. The optical system according to claim 1 satisfying a following conditional formula:
$$- 1.85 < FLB / f < - 0.45 , \qquad ( 4 )$$
here,
FLB is a focal length of the lens B.

8. The optical system according to claim 1 satisfying a following conditional formula:
$$18. < vdLB < 52. , \qquad ( 6 )$$
here,
vdLB is an Abbe constant at d-line of the lens B.

9. The optical system according to claim 1 satisfying a following conditional formula:
$$- 1.18 < CRBf / f < - 0.2 , \qquad ( 7 )$$
here,
CRBf is a curvature radius of an object side surface of the lens B.

10. The optical system according to claim 1 satisfying a following conditional formula:
$$f / EPD < 2.6 , \qquad ( 8 )$$
here,
EPD is an entrance pupil diameter of the optical system.

11. The optical system according to claim 1 satisfying a following conditional formula:
$$0.65 < FLA / f < 3.8 , \qquad ( 9 )$$
here,
FLA is a focal length of the lens A.

12. The optical system according to claim 1 satisfying a following conditional formula:
$$- 3.2 < ( CRBf + CRBr ) / ( CRBf - CRBr ) < - 0.53 , \qquad ( 10 )$$
here,
CRBf is a curvature radius of an object side surface of the lens B, and
CRBr is a curvature radius of an image side surface of the lens B.

13. The optical system according to claim 1 or 2 satisfying a following conditional formula:
$$1.42 < NdLA < 2.3 , \qquad ( 11 )$$
here,
NdLA is a refractive index at d-line of the lens A.

14. The optical system according to claim 1 satisfying a following conditional formula:
$$1.9 < \vert ff \vert / fR < 1000. , \qquad ( 14 )$$
here,
ff is a focal length of the front group, and
fR is a focal length of the rear group.

15. The optical system according to claim 1 satisfying a following conditional formula:
$$0.3 < TLAS / TLSB < 0.92 , \qquad ( 16 )$$
here,
TLAS is a distance from an object side surface of the lens A to the stop, and
TLSB is a distance from the stop to an image side surface of the lens B.

16. The optical system according to claim 1 satisfying a following conditional formula:
$$- 4.5 < CRBf / BF < - 1.2 , \qquad ( 17 )$$
here,
CRBf is a curvature radius of an object side surface of the lens B, and
BF is an air-equivalent distance from a lens surface on a most image side of the rear group to an image plane.

17. The optical system according to claim 1 satisfying a following conditional formula:
$$0.3 < vdLA / vdLB < 3. , \qquad ( 18 )$$
here,
vdLA is an Abbe constant at d-line of the lens A, and
vdLB is an Abbe constant at d-line of the lens B.

18. The optical system according to claim 1 satisfying a following conditional formula:
$$1. < TTL / f < 3.5 , \qquad ( 19 )$$
here,
TTL is a distance from a lens surface on a most object side of the front group to an image plane.

19. An imaging device comprising an image sensor, on an image side of the optical system according to claim 1, that converts an optical image formed by the optical system into an electrical signal.

20. A moving body comprising the imaging device according to claim 19.
